(19) United States
(12) Patent Application Publication
(10) Pub. No.: US 2009/0037962 A1
(43) Pub. Date: Feb. 5, 2009

(54) Alternate link on-demand instant replay supported via an internet protocol multimedia subsystem

(76) Inventors: David S. Benco, Winfield, IL (US); Harold A. Lassers, Elmhurst, IL (US); Anne Yin-Fee Lee, Naperville, IL (US)

Correspondence Address: FAY SHARPE/LUCENT, 1100 SUPERIOR AVE, SEVENTH FLOOR, CLEVELAND, OH, 44114, US

(21) Appl. No.: 11/890,013

(22) Filed: Aug. 3, 2007

(51) Int. Cl. H04N 7/173

(52) U.S. Cl. 725/88

(57) ABSTRACT

The present specification discloses is a method for providing a viewer (20) on-demand instant replay of live television (TV) being provided from a source (10) over a primary delivery channel. The method includes: obtaining a feed of the live TV supplied by the source (10); storing content from the obtained feed in a storage device (32); selecting a portion of the content from the storage device (32); and, delivering the selected portion of the content to a viewer's user equipment (UE) (24) while leaving uninterrupted the live TV provided by the source over the primary delivery channel.

### FIELD

The present inventive subject matter relates to the art of wireless telecommunications networks. Particular application is found in conjunction with an Internet Protocol (IP) Multimedia Subsystem, and the specification makes particular reference thereto. However, it is to be appreciated that aspects of the present inventive subject matter are also amenable to other like networks, devices and/or applications.

### BACKGROUND

In general, television (TV) networks provide a variety of content or programming to viewers through conventional delivery channels—examples include terrestrial broadcast TV, cable TV, satellite TV, etc. A real-time telecast of such content or programming is generally referred to herein as live TV.

As can be appreciated, a viewer may from time to time desire to see an instant replay of some selected portion of a live TV program or content they are watching. This may be particularly true, e.g., with respect to sporting events or other like content. Accordingly, various solutions have been developed to provide instant replays to viewers. However, these solutions tend to have certain limitations or drawbacks.

For example, as is common with the aforementioned genre in particular, when covering an event, the TV network may select specific portions of the event and provide an instant replay of those portions in the normal course of the telecast. However, the instant replay provided by the TV network may not coincide with the portion of the event that a particular viewer desires to see replayed. Moreover, telecasting the instant replay from the source of the telecast interrupts the otherwise live coverage the event and generally obligates all viewers receiving the telecast to also receive the instant replay.

Another solution utilizes set-top boxes (STBs) or consumer-based equipment at the receiving end of the telecast, e.g., such as a digital video recorder (DVR) (also known as a personal video recorder (PVR)) or other like equipment. Such equipment generally allows a viewer to pause, rewind and replay otherwise live TV as desired. However, it may at times be impractical or undesirable to use such equipment. For example, in many instances, a viewer may be watching a TV set that is not connected to or equipped with the appropriate SBT and therefore the instant replay function may not be available. In another case, the viewer may be part of a larger group of viewers, e.g., watching a sporting event at a bar. Accordingly, the viewer may not be able to personally exercise control over the instant replay feature even if it is available. Additionally, even if an individual viewer in the group is able to selectively replay desired portions of a televised event using the equipment, doing so may disrupt the other viewers' enjoyment of the live TV. In any event, the use of such receiving end equipment generally interrupts the otherwise live TV being viewed via the delivery channel accessed by the equipment.

Accordingly, a new and improved system and/or method is provided that overcomes the above-referenced problems and others.

### SUMMARY

One embodiment is directed to a method for providing a viewer on-demand instant replay of live television (TV) being provided from a source over a primary delivery channel. The method includes: obtaining a feed of the live TV supplied by the source; storing content from the obtained feed in a storage device; selecting a portion of the content from the storage device; and, delivering the selected portion of the content to a viewer's user equipment (UE) while leaving uninterrupted the live TV provided by the source over the primary delivery channel.

Another embodiment is directed to a system for providing viewers on-demand instant replay of live television (TV) being supplied from a source over a primary delivery channel. The system includes: receiving means for receiving a feed of the live TV supplied by the source; storage means for storing media content from the received feed; selection means for selecting portions of the content from the storage means in response to input received from viewers' user equipment (UE); and, delivery means for delivering the selected portions of the content to the respective viewers' UE while leaving uninterrupted the live TV supplied by the source over the primary delivery channel.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary network architecture suitable for practicing aspects of the present inventive subject matter.

FIG. 2 is a post and rail call flow diagram illustrating an exemplary manner in which an on-demand instant replay service is administered in accordance with aspects of the present inventive subject matter.

### DETAILED DESCRIPTION OF PREFERRED EMBODIMENTS

For clarity and simplicity, the present specification shall refer to structural and/or functional elements, relevant communication standards, protocols and/or services, and other components that are commonly known in the art without further detailed explanation as to their configuration or operation except to the extent they have been modified or altered in accordance with and/or to accommodate the preferred embodiment(s) presented herein.

Generally, the present specification relates to a system and/or method that provides a viewer an on-demand service for the instant replay of live TV content while leaving uninterrupted the corresponding real-time telecast received over a primary conventional delivery channel. More specifically, a TV network or other like source suitably provides a real-time telecast of a program, event or other content via a conventional delivery channel. Additionally, a feed of the live TV is also provided to an instant replay application server (IRAS) where it is stored, e.g., digitally. Accordingly, while watching live TV received over a primary conventional delivery channel, a viewer that subscribes to the on-demand instant replay service can selectively access the IRAS via an Internet Protocol (IP) Multimedia Subsystem (IMS) to replay on their wireless mobile user equipment (UE) a desired portion of the corresponding program, event or other content obtained from the IRAS while leaving the live TV received over the primary conventional delivery channel uninterrupted.

As is known in the wireless telecommunication arts, the IMS is an architectural framework (originally designed by the wireless standards body known as the 3rd Generation Partnership Project (3GPP)) for delivering IP multimedia to wireless mobile device users. That is to say, the IMS supports the use of IP multimedia applications and/or services within a wireless telecommunications system or network. Generally, the IMS enables wireless network service providers and/or operators to offer their subscribers (i.e., mobile users) multimedia services based on and/or built upon Internet applications, services and/or protocols (e.g., including SIP (Session Initiation Protocol), which is used to manage the IP multimedia sessions).

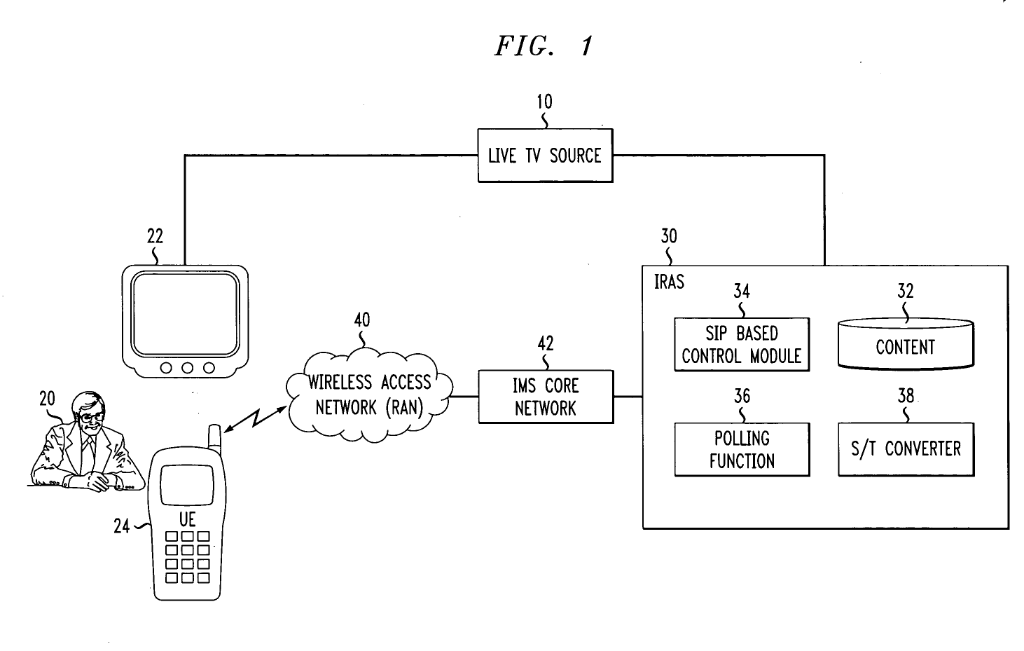

With reference now to FIG. 1, there is shown a live TV content provider or source 10 (e.g., a broadcast TV network, a cable TV network operator or provider, a satellite TV network operator or provider, or some other like source) that provides a real-time telecast of programming, events or other like content via a primary conventional delivery channel (e.g., such as terrestrial broadcast TV, cable TV, satellite TV, etc.). Suitably, as illustrated in FIG. 1, a viewer 20 selectively watches the live TV provided from the source 10 on a TV set 22 or other like TV viewing equipment or device that receives the live TV over the primary delivery channel. Additionally, a feed of the live TV from the source 10 is also supplied to or otherwise obtained by an instant replay application server (IRAS) 30 that provides an on-demand instant replay (ODIR) service to one or more subscribers, e.g., such as the viewer 20.

While only a single source 10 and viewer 20 are illustrated in FIG. 1 for clarity and simplicity herein, it is to be appreciated that in practice, at any given time, generally a plurality of similarly situated sources are providing a variety of live TV content via a plurality of primary delivery channels to a plurality of similarly situated viewers. Likewise, one or more of the plurality of sources optionally provide feeds to the IRAS 30 which in turn optionally provides the ODIR service to one or more of the plurality of viewers that optionally subscribe to the ODIR service.

As it is received, the IRAS 30 writes or otherwise stores the content from the obtained feed supplied by the source 10 to a suitable storage device 32 such that desired portions of the content can be selectively accessed by the viewer 20 using the ODIR service. For example, the storage device 32 is suitably an array or bank of random access hard discs or the like.

In a suitable embodiment, the viewer 20 selectively accesses the ODIR service by employing UE 24 which is served by a wireless access network 40 that provides the UE 24 access to the IRAS 30 via an IMS core network 42. In a suitable embodiment, the UE 24 is a mobile node (MN), e.g., a mobile telephone, wireless Personal Digital Assistant (PDA) or other suitable mobile station (MS) or mobile terminal (MT), that operatively communicates with the wireless access network 40 in the usual manner.

Generally, the wireless access network 40 is implemented with IP data carried over the Radio Access Network (RAN) operatively connected to and/or in communication with the IMS core network 42 in the usual manner. For example, in the RAN, one or more base stations are employed to provide a radio frequency (RF) or other suitable wireless or over-the-air interface with the UE 24. Each base station (BS) suitably provides the aforementioned interface in a designated geographic area served by the BS—i.e., in a particular cell served by the BS. Accordingly, as the UE 24 is carried from cell to cell by the viewer 20, the respective base stations serving those cells provide the UE 24 with the aforementioned interface to the RAN thereby operatively connecting the UE 24 with the IMS core network 42. Additionally, the RAN may also include a wide area local access network (WLAN) through which the UE 24 is operatively connected to the IMS core network 42 in the usual manner.

In the illustrated embodiment, a SIP based control module 34 allows the viewer 20 to selectively access desired portions of content from the storage device 32 and/or control the delivery thereof from the IRAS 30 to the UE 24 via the IMS core network 42. Suitably, a standard IMS Service Control (ISC) interface connects the IRAS 30 to the appropriate Call Session Control Function (CSCF) supported in the IMS core network 42, and a client on the UE 24 provides a convenient user interface for the viewer 20 to select and/or control the content delivery via the SIP based control module 34 in the IRAS 30. Accordingly, while live TV is being received over the primary delivery channel by the TV set 22, the viewer 20 which subscribes to the ODIR service is able to access the IRAS 30 from their UE 24 via the IMS core network 42 and select a desired portion of the corresponding content from the storage device 32 for delivery from the IRAS 30 over the IMS core network 42 to their UE 24 where the selected content can be replayed while leaving uninterrupted the live TV received by the TV set 22 over the primary conventional delivery channel.

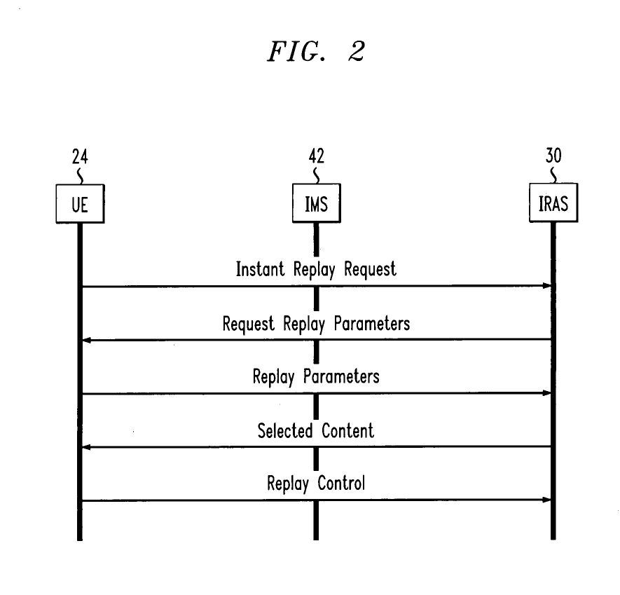

With reference now to FIG. 2, the illustrated call flow demonstrates an exemplary manner in which the ODIR service is administered by the IRAS 30 to the UE 24 via the IMS core network 42.

In the illustrated example, the viewer 20 initiates access to the ODIR service or otherwise invokes the service with their UE 24 by sending an “Instant Replay Request” message or other suitable signal to the IRAS 30 via the IMS core network 42. As shown, the IRAS 30 responds by retuning a “Request Replay Parameters” message or other suitable signal from the IRAS 30 to the UE 24 via the IMS core network 42. Accordingly, the UE 24 prompts the viewer 20 for desired replay parameters. For example, suitable replay parameters available for selection by the viewer 20 optionally include, without limitation: an identification of the program, event or content the viewer 20 wishes to replay (e.g., this may include the name of the TV network, such as ESPN, NBC, HBO, CBS, CNN, etc., and/or the title of the program, event or content, such as Ohio State Football Game, Monday Night Football, 20/20, etc.); an indication of how long ago or the time the viewer 20 wishes the replay to start (e.g., start the replay from 2 minutes ago or start at 5:34 PM Eastern Standard Time (EST) or the like); an indication of replay duration desired by the viewer 20 or a time at which the viewer 20 wishes the replay is to end (e.g., replay 1 minute or end at 5:35 PM EST); a speed at which the viewer 20 would like to see the replay (e.g., normal speed, slow motion, fast forward, etc.); and, a video quality the viewer 20 desires (e.g., high, medium or low resolution).

Suitably, the viewer 20 selects, enters or otherwise provides desired values for the replay parameters to the UE 24 and return the same from the UE 24 to the IRAS 30 via the IMS core network 42, e.g., in a “Replay Parameters” message or other suitable signal. While FIG. 2 shows the replay parameters being communicated via a single parameter request and corresponding response, alternately, any one or more of the replay parameters are optionally communicate via a plurality of separate parameter requests and corresponding responses. Moreover, optionally, any one or more of the replay parameters may accompany the initial “Instant Replay Request” thereby relieving the IRAS 30 from having to later request the parameter already provided. Additionally, in the absence of a particular parameter being provided, optionally the UE 24 and/or IRAS 30 supplies a default value therefor.

In any event, once the replay parameters are established, in accordance therewith the IRAS 30 selects the appropriate content from the storage device 32 and streams or otherwise delivers the selected content via the IMS core network 42 to the UE 24 for viewing by the viewer 20. Optionally, during delivery of the selected content on the UE 24, the viewer 20 may select one or more functions to control the received replay of the content. Consequently, based upon the viewer's selection, a corresponding “Replay Control” message or other suitable signal is sent from the UE 24 via the IMS core network 42 to the IRAS 30 which appropriately adjusts or otherwise regulates the content and/or delivery thereof in accordance with the selected function. For example, suitable replay control functions available for selection by the viewer 20 optionally include, without limitation: speeding up, slowing down or freezing the replay, rewinding or fast forwarding the replay, skipping ahead or jumping back in time, terminating the replay, extending the replay duration, changing the camera angle or zoom, restarting the replay, and altering the video quality.

Returning attention now to FIG. 1, the IRAS 30 is also optionally equipped or otherwise provisioned with a polling service or function 36, e.g., that monitors and/or tracks Instant Replay (IR) requests received by the IRAS 30 from subscribers such as the viewer 20. The polling function 36 detects, identifies and/or otherwise determines (e.g., via appropriate statistical or other suitable analysis) which portions of content—i.e., content clips—are the most popular or otherwise highly requested by subscribers. Accordingly, the identified clips are optionally utilized in a variety of suitable manners.

For example, the clips identified as sufficiently popular or highly requested by the polling feature 36 are optionally pushed or offered to subscribers by the IRAS 30. More specifically, when an IR request is received from the UE 24, the IRAS 30 optionally responds by sending the UE 24 a current list of the most popular clips for quick selection by the viewer 20. Alternately, if a particular clip reaches a sufficient level of popularity, it is optionally offered to selected subscribers. For example, the IRAS 30 optionally initiates contact with the UE 24, e.g., by sending an appropriate offer message or other suitable signal to the UE 24 over the IMS core network 42 or otherwise. Accordingly, upon receiving the offer, the UE 24 suitably prompts the viewer 20 with the option to receive the clip, e.g., by simply entering a designated feature code, selecting an appropriate link or otherwise. In another suitable embodiment, identified clips are maintained in a collection that is optionally stored or otherwise kept available post-telecast for selective access by subscribers after the fact or after the real-time telecast has otherwise ended.

In another suitable embodiment, the IRAS 30 is also equipped or otherwise provisioned with a speech to text (S/T) converter 38 which may be selectively invoked or otherwise activated by a subscriber such as the viewer 20 when requesting an IR from the IRAS 30. Accordingly, when the S/T converter 38 is invoked or activated, speech in the content provided from the IRAS 30 to the UE 24 via the IMS core network 42 is converted by the S/T converter 38 to text for viewing on the UE 24. Such a feature is particularly advantageous, say for example, if the viewer 20 just missed a significant spoken word or passage on live TV and wanted an instant replay with text to “see” what was said.

In yet another embodiment, optionally selected advertising is incorporated in the content provided to the UE 24 by the IRAS 30 via the IMS core network 42. Suitably, in addition to the content selected from the storage device 32 in accordance with the replay parameters selected by the viewer 20 or otherwise established, the advertising is also optionally delivered from the IRAS 30 to the UE 24 via the IMS core network 42, e.g., pre-pended and/or appended to the otherwise selected content and/or inserted in and/or overlaid on the otherwise selected content.

In still another suitable embodiment, the IRAS 30 not only provides the ODIR service, but also optionally provides an on-demand live TV service, e.g., by bridging or otherwise supplying the obtained real-time feed supplied by the source 10 to the UE 24 via the IMS core network 42.

In conclusion, it is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for providing a viewer on-demand instant replay of live television (TV) being provided from a source over a primary delivery channel, said method comprising:
(a) obtaining a feed of the live TV supplied by the source;
(b) storing content from the obtained feed in a storage device;
(c) selecting a portion of the content from the storage device; and,
(d) delivering the selected portion of the content to a viewer's user equipment (UE) while leaving uninterrupted the live TV provided by the source over the primary delivery channel.

2. The method of claim 1, said method further comprising:
receiving an instant replay request from the UE; and in response to the receipt of said request,
triggering execution of steps (c) and (d) in accordance therewith.

3. The method of claim 1, said method further comprising:
receiving a replay parameter from the UE; and in response to a value of said received replay parameter,
determining at least one of: what portion of the content is selected from the storage device, and an appearance of the content delivered to the UE.

4. The method of claim 1, wherein the delivered content is delivered to the UE via an Internet Protocol (IP) Multimedia Subsystem (IMS).

5. The method of claim 1, said method further comprising:
receiving a replay control signal from the UE during execution of step (d); and in response thereto,
altering the delivery so as to effect an appearance of the content delivered to the UE.

6. The method of claim 1, said method further comprising:
converting speech contained in the delivered content to text.

7. The method of claim 1, said method further comprising:
monitoring at least one of an amount of times or a frequency with which a given portion of content is selected from the storage device in step (c) to determine a popularity thereof.

8. A system for providing viewers on-demand instant replay of live television (TV) being supplied from a source over a primary delivery channel, said system comprising:
receiving means for receiving a feed of the live TV supplied by the source;
storage means for storing media content from the received feed;
selection means for selecting portions of the content from the storage means in response to input received from viewers' user equipment (UE); and,
delivery means for delivering the selected portions of the content to the respective viewers' UE while leaving uninterrupted the live TV supplied by the source over the primary delivery channel.

9. The system of claim 8, wherein the delivery means includes an Internet Protocol (IP) Multimedia Subsystem (IMS).

10. The system of claim 9, wherein the delivery means further includes a wireless access network through which the viewers' UE selectively communicate with the IMS.

11. The system of claim 10, wherein the UE of each viewer is a mobile node served by the wireless access network.

12. The system of claim 8, wherein the storage means includes a random access hard disc array.

13. The system of claim 8, said system further comprising:
conversion means for converting speech contained in the delivered content to text.

14. The system of claim 8, said system further comprising:
polling means for monitoring at least one of an amount of times or a frequency with which a given portion of content is selected by the selection means to determine a popularity thereof.

15. The system of claim 8, said system further comprising:
means receiving the live TV supplied by the source over the primary delivery channel.
